(19) United States
(12) Patent Application Publication
(10) Pub. No.: US 2003/0160515 A1
(43) Pub. Date: Aug. 28, 2003

(54) Controllable broad-spectrum harmonic filter (cbf) for electrical power systems

(76) Inventors: Luke Yu, San Marino, CA (US); Henry Yu, San Marino, CA (US)

Correspondence Address: LUKE YU, 2173 E. CALIFORNIA BLVD., SAN MARINO, CA, 91108, US

(21) Appl. No.: 10/237,281

(22) Filed: Sep. 9, 2002

Related U.S. Application Data
(60) Provisional application No. 60/349,711, filed on Jan. 22, 2002.

(30) Foreign Application Priority Data
Jan. 15, 2002 (CA) 2367816

(51) Int. Cl. H02J 1/02

(52) U.S. Cl. 307/105

(57) ABSTRACT

A broad-spectrum harmonic filter is developed. This filter is to be connected in series ahead of the load which generates harmonics. This filter basically consists of 3 fixed elements, i.e. a series reactor and a shunt reactor in series with a capacitor. It can function to completely filter out 5^{th} harmonic current in 3 phase systems (or 3^{rd} harmonic current in single phase systems) and to reduce other harmonic components by high percentages say, typically close to 70%. Thus the portions of various harmonics flowing toward the electrical power source can be held within acceptable limits. By adjusting these two reactors and the capacitor, a desirable and controllable filtering performance can be achieved. A satisfactory performance of the filter and the electrical system can be expected by use of this invented filter with only 3 major elements.

A voltage compensator, a reactor of “negative value” is recommended to compensate for the harmonic voltage distortion across the series reactor (or the filter), if necessary, or to compensate for the voltage drops under power frequency operations.

This application claims the benefits of provisional patent application serial number 60/349711 filed on Jan. 22, 2002.

The applicants Luke Yu, a U.S. citizen whose complete address is 2173 E. California Blvd, San Marino, Calif. 91108, and Henry Yu, a U.S. citizen whose complete address 2173 E. California Blvd, San Marino, Calif. 91108, submit a patent for an invention entitled “CONTROLLABLE BROAD-SPECTRUM HARMONIC FILTER (CBF) FOR ELECTRICAL POWER SYSTEMS”,

### CROSS REFERENCE TO RELATED APPLICATIONS

| | | | |
|---|---|---|---|
| 3733536 | 05/1973 | Gillow et al. | 324/127 |
| 5663636 | 09/1997 | Falldin et al. | 323/361 |
| 5751563 | 05/1998 | Bjorklund | 363/35 |
| 5754034 | 05/1998 | Ratiliff et al. | 323/206 |
| 6043569 | 03/2000 | Ferguson | 307/105 |
| 6127743 | 10/2000 | Levin et al. | 363/40 |

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

This invention relates to broad-spectrum harmonic filtration by use of inductor and capacitor combination for single and multiphase electrical power systems. This invented filter can filter out all harmonics with high percentages of attenuation and thereby significantly reduce harmonics injected into the power source while the conventional L-C type (inductor-capacitor in series) filter is tuned at and can only filter one specific harmonic. The filtering performance can be controlled by proper selection of its design parameters. If reduction of the total harmonic voltage distortion across the filter is required, a voltage compensator (a reactor of “negative value”) may be included in the design.

Adjustable speed drives (ASD) are widely used in 3 phase 3 wire electrical systems. Those drives generate harmonics such as 5^{th}, 7^{th}, 11^{th}, etc which may feed back into the source power system.

Typically, the harmonic magnitudes in terms of ASD motor load current are as follows, expressed in per unit (pu) values:

| | | | | | | | | | |
|---|---|---|---|---|---|---|---|---|---|
| Harmonic | 1 | 5 | 7 | 11 | 13 | 17 | 19 | 23 | 25 |
| order | | | | | | | | | |
| Magni- | 1 | 0.2 | .12 | .08 | .07 | .045 | .04 | .03 | .03 |
| tude, pu | | | | | | | | | |

These harmonic currents flow toward the electrical system and create harmonic voltage distortion and other adverse effects in both the electrical systems and other elements. This has been well documented and long known to the industry.

Eliminating or reducing harmonics has become a topic for research and development with great significance. For 3 phase, 3 wire systems, the most popular filtering equipment is as follows:

1. Shunt L-C tuned filter: This type of filter, consisting of an inductor and a capacitor in series is widely used in industry for harmonic elimination purposes. By proper selection of values of the inductor and capacitor, a tuned filter can be created. Such a filter is very effective, but only for the specific harmonic for which it is tuned. Typically such filters are tuned for the 5^{th} harmonic which has the highest magnitude of all in three phase ASD systems. However, this tuned filter becomes a high impedance path to other harmonics resulting in the other harmonics flowing toward the electrical system due to its relatively low impedance as compared to the filter impedance. In order to achieve useful harmonic elimination or reduction to an acceptable limit, many tuned filters are required in each separate application This is an expensive method of harmonic reduction.

2. Active filter:

This type of filter injects harmonic currents of opposing sense in order to cancel the generated harmonic currents. It is an effective method. However it is very costly and consists of many electronic components arranged in complex circuits. Its applications are limited.

Power factor correction capacitors very commonly exist in electrical distribution systems. They cannot alleviate harmonics, but may in turn aggregate harmonics and create system resonance, higher capacitor currents and possible capacitor burn-out.

Presently, tuned L-C shunt filters are most commonly used.

### BRIEF SUMMARY OF THE INVENTION

The main objectives in developing a new filter are as follows:

1. One filter should be able to absorb all harmonics in high percentages. This has great significance in low initial cost for equipment and minimizing space required by the filtering equipment.

2. The filter should be very simple, reliable and maintenance free. Complex circuits such as the active filter should be avoided.

3. The filter should be applicable regardless of the nature of the loads (including ASD, uninterruptible power supplies (UPS), arc furnaces, or D.C. transmission system), and regardless of the voltage levels, the of number of phases and the power frequencies.

4. The filter should meet various critical performance criteria such as:

a. Acceptable voltage regulation under power frequency operations from full load to half load.

b. Good filtering efficiency resulting in acceptable total harmonic current distortion and total harmonic voltage distortion.

5. The filter parameters should be easily selected and designed to meet the requirements.

The following criteria are set for developing the invention as follows:

1. A series reactor is needed to block the harmonics flowing from the load towards the source. This series reactor should be selected with power frequency voltage drop and harmonic voltage distortion considered.

2. A shunt reactor in series with a capacitor is employed to absorb harmonics. Due to the fact that the 5^{th} harmonic has the highest magnitude among harmonics in 3 phase systems, the relation between these two elements is set to achieve theoretically zero filter impedance at 5^{th} harmonic. i.e. 5²×inductive reactance of shunt reactor=capacitive reactance of capacitor. Thus they become a theoretically zero impedance path for 5^{th} harmonic in order to approach the theoretical limit of 100% filtering efficiency. This shunt impedance should become far smaller than the series impedance for all other high order harmonics. The capacitor would also serve for power factor correction and reduce the power frequency voltage drop during operations.

For single phase systems (including 3 phase 4 wire systems with single phase loads), the 3^{rd} harmonic is of the highest magnitude among harmonics. The design concept is identical to that of 3 phase systems to achieve 100% filtering efficiency for 3^{rd} harmonics.

3. A voltage compensating element may be required. It is used to compensate for the power frequency voltage drop and harmonic voltage distortion across filter only if the filter without a compensating element cannot meet the requirements of the voltage drop and/or harmonic voltage distortion across the filter.

Thus a basic single phase model of this invention is developed and consists of only three elements, i.e. a series reactor, X₁2, a shunt reactor X₂3 and a capacitor X_{c}4 as shown in FIG. 1 where the reactances represent the reactors and capacitor respectively.

The filtering efficiency of the filter can be controlled by proper design and selection of the components which in turn is based on a given system, equipment voltage tolerances and user's requirements such as filtering efficiency, required limits of power factor, voltage drop, harmonic distortion, etc. Further, the filter efficiency may be made adjustable by field adjustments of taps on the reactors.

With proper selection of the parameters of the filter, satisfactory performance results can be achieved, as shown in Table 1 and Table 2 in the later section.

For 3 phase applications, 3 filter units are needed while only one unit is required for single phase, two wire applications.

### BRIEF DESCRIPTION OF THE SEVERAL VIEWS OF THE DRAWINGS

FIG. 1 is a basic schematic view of a preferred embodiment of the invention. Both series reactor X₁2 and shunt rector X₂3 should be made of air (or non-magnetic) gapped core in order to obtain constant inductance over broad frequencies.

FIG. 2 is a typical schematic view of a preferred embodiment with a voltage compensating element added to the basic scheme.

FIG. 3 is a preferred embodiment of the construction of a single phase reactor with one portion having a “negative value” for voltage compensation purposes.

In the figures, like elements are designated with similar reference numerals.

### DETAILED DESCRIPTION OF THE INVENTION

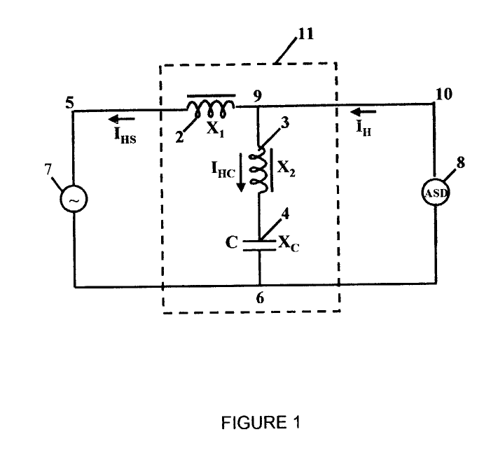

FIG. 1 shows a basic embodiment of the invented broad-spectrum harmonic filter consisting of 3 major elements: a series reactor X₁2, a shunt reactor X₂3 and a series capacitor C4 with shunt reactor X₂3 connected to terminal 9. The filter 11 is connected to a bus or a secondary side of an isolation transformer, not shown, at terminal 5. The supply side is represented as a source 7. The load side is shown as ASD 8, which in fact is an adjustable speed drive with its output connected to a 3-phase motor (not shown). The filter 11 is connected to the source at terminal 5 and to load at terminal 10. Point 6 is the neutral point of a three phase circuit and is a common connecting point for source, capacitor and load.

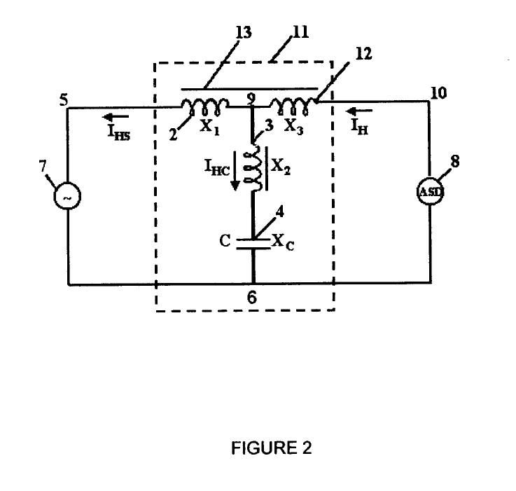

The magnitude of the impedance of the series reactor X₁2 is greater than that of X₂3 resulting in a low impedance path to capacitor C4 for all harmonics generated by load 8. In FIG. 1, terminal 9 and 10 are designated the same point for convenience of discussion. It is a common practice for a 0.03 pu (or higher) reactor to be installed ahead of an ASD in order to obtain reduced harmonics. FIG. 2 includes an additional series reactor X₃12. This series reactor X₃12 may represent the series reactor now commonly employed with ASD's.

The harmonic currents I_{H} flow toward series reactor X₁2 and shunt reactor X₂3 in series with capacitor C4. The portions of harmonic currents flowing between them can be determined by circuit theory as follows:

X₁I_{HS}=I_{HC}(X₂−X_{C}/h²)

where h is the harmonic order and I_{H}=I_{HS}+I_{HC}

X₁(I_{H}−I_{HC})=X₁I_{H}−X₁I_{HC}

∴I_{HC}=(X₁X_{H})/(X₁+X₂−X_{C}/h₂) (1)

I_{HS}=(X₂−X_{C}/h²)I_{H}/(X₁+X₂−X_{C}/h²) (2)

Equation 1 shows that when h²X₂=Xc, I_{HC}=100% I_{H} that means for instance in 3 phase systems the 5^{th} harmonic current flows completely toward the capacitor, with no portion flowing toward the source. The portion of higher order harmonics which flows toward the capacitor will decrease gradually toward a X₁/(X₁+X₂) limit.

Based on a typical harmonic spectrum and the selected parameters of the basic filter model, filtering efficiencies, reduction of total current distortion, the reduction of total harmonic voltage distortion and voltage regulation under power frequency operations were computed with satisfactory results. The harmonic currents fed back into the power system complies with IEEE Standard 519 limits. The individual harmonic current distortion is below 3% and total harmonic current distortion is below 5%. The selected parameters and performances are listed in Table 1.

In this calculation, per unit system was adopted: motor KVA=1.0 pu, system Voltage=1.0 pu.

The calculations are based on the typical harmonic spectrum as listed before. Achieved results will vary with power system, filter, and load parameters.

TABLE 1
X₁ = 0.15 pu X₂ = 0.08 pu X_{c} = 2 pu

| | | | | | | | | |
|---|---|---|---|---|---|---|---|---|
| Harmonic order (h) | 5 | 7 | 11 | 13 | 17 | 19 | 23 | 25 |
| Harmonic current (I_{H}) pu | 0.2 | 0.12 | .08 | .07 | .045 | .04 | .03 | .03 |
| Filtering Efficency % | 100 | 79.3 | 70 | 68 | 67 | 67 | 66 | 66 |
| Harmonic current | | | | | | | | |
| toward source (I_{SH}) pu | 0 | .025 | .0238 | .0218 | .015 | .0133 | .01 | .01 |

Reduction of Total Harmonic Current Distortion = 100% − 18% = 72%
Reduction of Total Harmonic Voltage Distortion = 100% − 27.7% = 62.3%
Total Harmonic Current Distortion = .04763 pu

| | | | | |
|---|---|---|---|---|
| Voltage Regulation | Load Current Power Factor | 0.8 | 0.95 | 0.9 |
| Under power frequency | | | | |
| Operation, pu | Full Load | 1.02 | 1.03 | 1.04 |

Notes:
1. Total Current Distortion = (Σ(I_{H})²)^{1/2}/I₁
Total Voltage Distortion = (Σ(I_{H} * h * x)²)^{1/2}/V₁

Where V₁ and 1 are the fundamental voltage and current.

I_{H} is the harmonic current, and h is the harmonic order

And X is the reactance in which the harmonics flow through.

Reduction of Total Current Distortion=100%−(current distortion with filter/current distortion without filter)×100%=100%−0.04763/0.267×100%=72%

Reduction of Total Voltage Distortion=100%−(voltage distortion with filter/voltage distortion without filter)×100%=100%−(0.651X/2.35X)100%=62.3%

2. Normally, the equipment input voltage range is 1.0 pu+/−10%.

If existing system impedance at the point of connecting the filter and the load is considered, say 5% for conservatism, X₁ becomes (0.15 pu+0.05 pu)=0.2 pu The filtering efficiency of the filter and the reduction of distortion are listed on Table 2. Obviously, Table 2 performance is better than that of Table 1 due to higher X₁ value.

TABLE 2
X₁ = 0.2 pu X₂ = 0.08 pu X_{c} = 2 pu

| | | | | | | | | |
|---|---|---|---|---|---|---|---|---|
| Harmonic | 5 | 7 | 11 | 13 | 17 | 19 | 23 | 25 |
| order (h) | | | | | | | | |
| Filtering | 100 | 83.6 | 76 | 75 | 73.2 | 72.9 | 72.4 | 72.3 |
| Efficiency % | | | | | | | | |

Reduction of Total Current Distortion =
100% − .03834/0.267 × 100% = (100 − 14.36) % = 86%
Reduction of Total Voltage Distortion =
100% − ..529/2.35 × 100% = (100 − 22.5) % = 77.5%

In view of listed performance calculations in Table 1 and 2, a satisfactory result is demonstrated.

By proper selection of the 3 parameters, a desired filter and system performance can be achieved. Thus this simple basic model of filter is valid for applications.

However, due to the existence of X₁2, the total harmonic voltage distortion across X₁2 (or the filter) can be computed based on the given harmonic spectrum and filtering efficiency. The total harmonic voltage distortion of X₁2 due to flow of harmonics I_{HS} is VDₓ₁=0.651×0.15=0.0977 pu or 9.8% which is normally acceptable based on 10% limit shown in IEEE Standard 519.

If this harmonic voltage distortion across the filer is not acceptable, a “Voltage Compensator” may be introduced and will be added to the basic model of the filter and is represented as X₃12 as shown in FIG. 2.

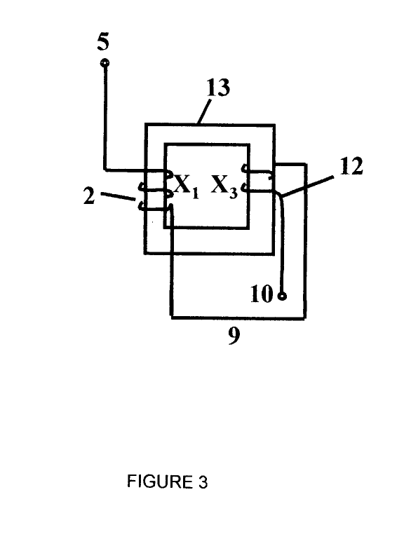

As shown in FIG. 2, X₁2 and X₃12 are connected to X₂3 and X_{c}4 at terminal 9 and the other end of X₃12 is connected to the load at terminal 10. X₃12 is the voltage compensator which is designed to create a reactance in opposite sense to another series reactor X₁2. In fact X₃12 is the extended portion of the series reactor X₁2 and is wound in the reverse direction to that of X₁2. Thus it is in fact a reactor with two sections, X₁2 and X₃12. By proper selection of X₃12, the harmonic voltage distortion of X₃12 due to I_{H}, will compensate and cancel harmonic voltage distortion of X₁2 due to I_{HS} for a given harmonic spectrum and filtering efficiency. The details of construction to obtain a reactance in opposite sense to another one will be shown in the discussion of FIG. 3.

Due to the fact that no separate negative reactor is available, the effect of a “negative reactor” is achieved in a real reactor with two coils, one coil being wound in the opposite direction to the other.

FIG. 3, shows a core 13 with coil portion X₁2 and coil portion X₃12 in series which are wound on 2 legs of the core and are transposed at point 9 in opposite sense so the fluxes they produce oppose each other. These 2 coil portions create a mutually coupled circuit and a mutual reactance X_{M}. This mutual reactance X_{M} is a function of X₁2 and X₃12. Due to the existence of X_{M}, reactance of coil portion X₁2 becomes (X₁-X_{M}) and reactance of the other coil portion X₃12 becomes—(X_{M}-X₃) which is a “negative reactance” where X_{M}>X₃. Reactance X₁2 and X₃12 and mutual reactance XM can be designed and constructed. Thus the physical structure can be represented as 2 reactors in series, one of which has an opposite sign to the other. The filter 11 consists of X₁2 and X₃12 with its terminal ends connected to source at terminal 5 and to load at terminal 10, while terminal 9 is for connection to X₂3 as shown in FIG. 2.

By proper selection of X₁2 and X₃12 and the desired X_{M}, a desired compensation to harmonic voltage distortion across filter (or X₁2) may be achieved provided that X_{M} is selected and designed to exceed the value of X₃12. With the addition of X₃12, new equations are derived for I_{H} flowing through X₃12 and I_{SH} flowing through X₁2 as follows:

X₁I_{HS}−I_{H}X_{M}=I_{HC}(X₂−X_{C}/h²)

X₁(I_{H}−I_{HC})−I_{H}X_{M}=I_{H}(X₁−X_{M})−I_{HC}X₁

∴I_{HC}=(X₁−X_{M})I_{H}/(X₁+X₂−X_{C}/h₂) (3)

I_{HS}=(X₂+X_{M}−X_{C}/h²)I_{H}/(X₁+X₂−X_{C}/h²) (4)

To meet the requirement of 100% filtering efficiency for 5^{th} harmonic:

X₁X_{M}=X₁+X₂−X_{C}/5²

∴X₂ should be equal to (X_{C}/5²−X_{M}) (5)

Thus harmonic voltage distortion across X₁ (or the filter) can be expressed as

X₁I_{HS}−X_{M}I_{H}+I_{H}X₃−I_{HS}X_{M}=I_{HS}(X₁−X_{M})−I_{H}(X_{M}−X₃) (6)

It is important to point out that the calculations must be made for each harmonic and then the total harmonic voltage distortion as shown in Note 1 of Table 1.

From equation (4) and (6), I_{HS} and the filter harmonic voltage distortion across the filter can be determined, as the reduction of harmonic voltage distortion across the filter as compared to that without X₃12.

In actuality if the (X₁−X_{M}), is too low, a series fixed reactor is recommended to add ahead of X₁2. Optimum selection of parameters is needed to meet the specific requirements of a particular design application.

1. As shown in FIG. 1, a broad-spectrum harmonic filter of single phase type is made of basically 3 elements: a series reactor of high magnitude, a shunt reactor of low magnitude and a capacitor in series with the shunt reactor. The performance of this filter is determined by the selection of values of the series reactor, the shunt reactor and the capacitor.

2. As shown in FIG. 2, a voltage compensator (a reactor of “negative values”) is utilized in addition to the basic filter shown in FIG. 1. It serves to compensate for the harmonic voltage distortion of the filter and/or the voltage drop under power frequency operations.

3. As cited in claim 1 and 2, a 3-phase unit consisting of three single phase units may be constructed for 3-phase applications.

4. As shown in FIG. 3, the voltage compensator is a portion of a coil, wound in the reverse direction to the other portion of the coil on the same magnetic core. This reverse wound portion should always have a smaller reactance than that of the other portion. This reverse wound portion of the coil becomes a “negative reactance” in opposite sense to that of the other portion of the coil. Both section reactances are determined by the sum of their individual reactance and the mutual reactance between them. The criterion is to have X_{M}>X₃.

5. As cited in claim 4, similarly a 3 leg magnetic core with 6 coils can be utilized to make a 3-phase unit.

6. As cited in claim 1, a shunt reactor of specially made and designed may replace the shunted L-C type filter to function as a low impedance path for harmonics. This special reactor should function as a high inductance reactance under such power frequency and become a low inductive reactance over broad harmonic frequencies. The series reactor is remained to be adopted in order to control the filtering efficiency.

7. As cited in claim 1, an additional shunt reactor may be utilized in parallel with shunt reactor in series with a capacitor. This additional reactor will draw power frequency reactive current to compensate the capacitive current and to reduce voltage rise across the series reactor to a desired value.
It should be understood that any slight variation of the filter design accomplished by adding minor elements or changing of parameters may be made with reference to a preferred embodiment as claimed, without departing from the concept and scope of this invention.
